(19) United States
(12) Patent Application Publication
(10) Pub. No.: US 2026/0261206 A1
(43) Pub. Date: Sep. 3, 2026

(54) SWITCHING CONVERTER WITH ADAPTIVE PULSE FREQUENCY MODULATION ENTRY

(71) Applicant: TEXAS INSTRUMENTS INCORPORATED, Dallas, TX (US)

(72) Inventors: Anmol Sharma, Milpitas, CA (US); Kevin Scoones, San Jose, CA (US); Orlando Lazaro, Cary, NC (US); Reza Sharifi, Sunnyvale, CA (US)

(21) Appl. No.: 19/342,862

(22) Filed: Sep. 29, 2025

Related U.S. Application Data
(60) Provisional application No. 63/764,685, filed on Feb. 28, 2025.

(51) Int. Cl. H02M 3/157; H02M 1/00

(52) U.S. Cl. CPC H02M 3/157; H02M 1/0009

(57) ABSTRACT

An apparatus includes a power stage circuit having a first control input and first and second voltage terminals. A comparator has first and second inputs and an output. The output couples to the first control input. A current sense terminal couples to the second input of the comparator. A scaling circuit has a first input and an output. The first input of the scaling circuit couples to the second voltage terminal. The output of the scaling circuit couples to the first input of the comparator. The scaling circuit generates a first signal at the output of the scaling circuit based on a voltage at the first input of the scaling circuit. The power stage circuit enables pulse frequency modulation (PFM) based on a change in logic state of a second signal at the output of the comparator from a first logic state to a second logic state.

### CROSS-REFERENCE TO RELATED APPLICATIONS

This application claims priority to U.S. Provisional Patent Application No. 63/764,685, titled “Peak Current Scaling for a Wide Input or Output Voltage SMPS,” filed Feb. 28, 2025, and incorporated herein by reference.

### TECHNICAL FIELD

The present disclosure relates generally to an electronic system and method, and, in particular embodiments, to a switching converter with adaptive pulse frequency modulation entry.

### BACKGROUND

Switching converters produce an output voltage based on an input voltage, Examples of switching converters include buck converters, boost converters, buck-boost converters, and fly-back converters. Switching converters may operate in pulse width modulation (PWMVL) mode of operation or in a pulse frequency modulation (PFM) mode of operation. A switching converter may operate in the PWM mode for higher load conditions (e.g., higher load currents) and in the PFM mode for lower load conditions. In the PWM mode of operation, the switching converter operates according to a pulsing signal (with a fixed frequency), in which the duty cycle of such signal is regulated to maintain a regulated output voltage. In the PFM mode of operation, the switching converter operates in accordance with a pulsing signal (with fixed pulse duration), in which the frequency of the pulsing signal is regulated to regulate the output voltage.

### SUMMARY

In one embodiment, an apparatus includes a power stage circuit having a first control input and first and second voltage terminals. A comparator has first and second inputs and an output. The output couples to the first control input. A current sense terminal couples to the second input of the comparator. A scaling circuit has a first input and an output. The first input of the scaling circuit couples to the second voltage terminal. The output of the scaling circuit couples to the first input of the comparator. The scaling circuit generates a first signal at the output of the scaling circuit based on a voltage at the first input of the scaling circuit. The power stage circuit enables pulse frequency modulation (PFM) based on a change in logic state of a second signal at the output of the comparator from a first logic state to a second logic state.

In another embodiment, an apparatus includes a power stage circuit including a transistor and having a first control input, a first voltage terminal, and a second voltage terminal. A comparator has a first input, a second input, and an output. The output is coupled to the first control input. A current sense terminal is coupled to the first input of the comparator. A scaling circuit has a first input, a second input, and an output. The first input of the scaling circuit is coupled to the second voltage terminal, and the output of the scaling circuit is coupled to the second input of the comparator. The scaling circuit is configured to generate a first signal at the output of the scaling circuit based on a voltage at the first input of the scaling circuit and a second signal at the second input of the scaling circuit. The power stage circuit is configured to turn off the transistor in response to a third signal at the output of the comparator changing from a first logic state to a second logic state.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a circuit schematic of a switching converter, in accordance with an embodiment of the present disclosure;

FIG. 2A is a circuit schematic of the power stage circuit of the switching converter of FIG. 1 in which the power stage circuit is for a buck converter, in accordance with an embodiment of the present disclosure;

FIG. 2B is a circuit schematic of the power stage circuit of the switching converter of FIG. 1 in which the power stage circuit is for a boost converter, in accordance with an embodiment of the present disclosure;

FIG. 2C is a circuit schematic of the power stage circuit of the switching converter of FIG. 1 in which the power stage circuit is for a multi-level converter, in accordance with an embodiment of the present disclosure;

FIG. 2D is a circuit schematic of a logic circuit usable in any of the power stage circuits of FIGS. 2A, 2B, and 2C, in accordance with an embodiment of the present disclosure;

FIG. 3 is a waveform of inductor current, in accordance with an example;

FIG. 4 are graphs of inductor ripple current and a current threshold for transition to pulse frequency modulation operation based on output voltage, in accordance with an example; and

FIG. 5 is a circuit schematic of the scaling circuit of the switching converter of FIG. 1, in accordance with an embodiment of the present disclosure;

FIG. 6 is a circuit schematic of a switching converter, in accordance with another embodiment of the present disclosure;

FIG. 7 is a circuit schematic of the scaling circuit of the switching converter of FIG. 6, in accordance with an embodiment of the present disclosure;

FIG. 8 is a circuit schematic of a switching converter, in accordance with another embodiment of the present disclosure;

FIG. 9 is a circuit schematic of the scaling circuit of the switching converter of FIG. 8, in accordance with an embodiment of the present disclosure;

FIG. 10 is a circuit schematic of a switching converter, in accordance with another embodiment of the present disclosure;

FIG. 11 is a circuit schematic of a ramp generator of the switching converter of FIG. 10, in accordance with an embodiment of the present disclosure;

FIG. 12 is an example waveform of a ramp signal generated by the ramp generator of FIG. 11;

FIG. 13A is an example waveform of a peak reference current generated by the switching converter of FIG. 10 for a first level of load current; and

FIG. 13B is an example waveform of a peak reference current generated by the switching converter of FIG. 10 for a second level of load current.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” or “an example” in this description indicate that a particular configuration, structure or feature described in relation to the embodiment is included in at least one embodiment. Consequently, phrases such as “in one embodiment” or “in one example” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

A switching converter may operate in the PWM mode or in the PFM mode. In the PWM mode, the duty cycle of the converter may be adjusted to maintain a regulated output voltage. In the PFM mode, the converter's controller implements an on-phase, an off-phase, and a high impedance (HIZ) phase during each switching cycle. The on-phase may be initiated based on the output voltage falling below a threshold. During the on-phase, current increases through the converter's inductor. The off-phase may be initiated when the inductor's current reaches a peak threshold. During the off-phase, the inductor's current decreases. During the HIZ phase, the inductor's current is approximately 0 amperes. The converter's “load condition” refers to the level of load current produced by the converter. The PWM mode may be implemented for higher load conditions, and the PFM mode may be implemented for lower load conditions. The time duration of the HIZ phase (T_HIZ) during PFM operation may be based on the load condition. For example, T_HIZ may become longer for lower load conditions and may become shorter for higher load conditions.

The switching converter may transition between the PWM and PFM modes of operation based on the load condition. In some switching converters, the controller may transition from the PWM mode to the PFM mode in response to the inductor current falling below a fixed, static current level. Inductor ripple current refers to the peak-to-peak variation of inductor current.

In accordance with an embodiment of the present disclosure, to avoid large levels of negative inductor current during the PWM mode, the level of inductor current at which the PFM mode is entered from the PWM mode may be based on the level of inductor ripple current. In an example of a three-level switching converter operating at or near 50% duty cycle, the inductor current ripple may be small, as is further explained below. Consequently, in some such embodiments, a zero-crossing inductor current-based PFM mode entry may result in the converter remaining in the PWM mode even at low load conditions.

While a switching converter is in the PFM mode, a fixed level for the peak inductor current may be problematic, particularly, for wide input voltage boost converters and wide output voltage buck converters. For example, for a wide input voltage boost converter, as the output voltage increases, the inductor ripple current may increase. Using a fixed peak current in the PFM mode may result in a higher switching frequency and lower efficiency as the load condition increases. For increased efficiency, the fixed peak inductor current threshold may be set to a higher value. However, a higher value for the fixed peak inductor current threshold may result in larger output voltage ripple at lower load conditions. Accordingly, a tension exists between whether to set the fixed peak inductor current threshold at a higher level, which is beneficial for increased efficiency, or at a lower level, which is beneficial for reduced output voltage ripple.

In some embodiments, a switching converter (a boost converter is presented as an example) may dynamically adjust the inductor current threshold at which the converter transitions from the PWM mode to the PFM mode of operation. The dynamic adjustment of the inductor current threshold is based, at least in part, on the output voltage. In some embodiments, the switching converter may dynamically scale the peak inductor current threshold during PFM operation to provide a higher peak inductor current threshold for higher load conditions and a lower peak inductor current threshold for lower load conditions.

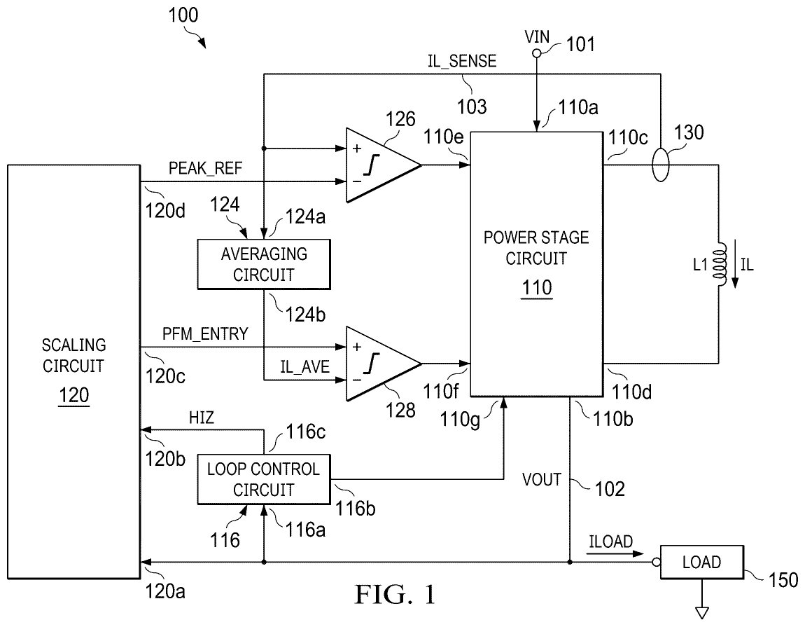

FIG. 1 is a circuit schematic of a switching converter 100, in accordance with an embodiment of the present disclosure. Switching converter 100 includes a power stage circuit 110, a loop control circuit 116, a scaling circuit 120, an averaging circuit 124, comparators 126 and 128, and an inductor L1. Switching converter 100 has an input voltage terminal 101, which receives an input voltage VIN, and an output voltage terminal 102, which provides an output voltage VOUT. A load 150 may be coupled to the output voltage terminal 102 to receive VOUT for the operation of load 150. The current to load 150 is ILOAD. Switching converter 100 may be a buck converter, a boost converter, or a buck-boost converter. Further, switching converter may be a multi-level switching converter in which the number of levels is 2, 3, or higher.

In one embodiment, power stage circuit 110, loop control circuit 116, scaling circuit 120, averaging circuit 124, and comparators 126 and 128 may be fabricated on a common integrated circuit (IC) and inductor L1 may be external to that IC. In another embodiment, inductor L1 may be on the same IC. In another embodiment, any one or more of power stage circuit 110, loop control circuit 116, scaling circuit 120, averaging circuit 124, and comparators 126 and 128 may be external to the IC containing the remaining components.

The switching converter's output voltage terminal 102 is coupled to the input 116a of loop control circuit 116 and to the input 120a of scaling circuit 120. Accordingly loop control circuit 116 and scaling circuit 120 receive VOUT at their respective inputs 116a and 120a. Output 116b of loop control circuit 116 is coupled to an input 110g of power stage circuit 110. Output 116c of loop control circuit 116 is coupled to input 120b of scaling circuit 120.

Comparators 126 and 128 have a positive (+) input and a negative (−) input. In the embodiment of FIG. 1, the output 120c of scaling circuit 120 is coupled to the positive input of comparator 128 and provides a signal PFM_ENTRY. The output 120d of scaling circuit 120 is coupled to the negative input of comparator 126 and provides a signal PEAK_REF. Averaging circuit 124 has an input 124a and an output 124b. A current sensor 130 is coupled to inductor L1 and sense the inductor current IL. In one embodiment, current sensor 130 may include a resistor (e.g., a low resistance sense resistor) whose voltage is a function of IL. The voltage across such resistor may be amplified and provided as inductor sense signal IL_SENSE 103 to the input 124a of averaging circuit 124 and to the positive input of comparator 126. The output 124b of averaging circuit 124 is coupled to the negative input of comparator 128. The outputs of comparators 126 and 128 are coupled to inputs 110e and 110f, respectively, of power stage circuit 110.

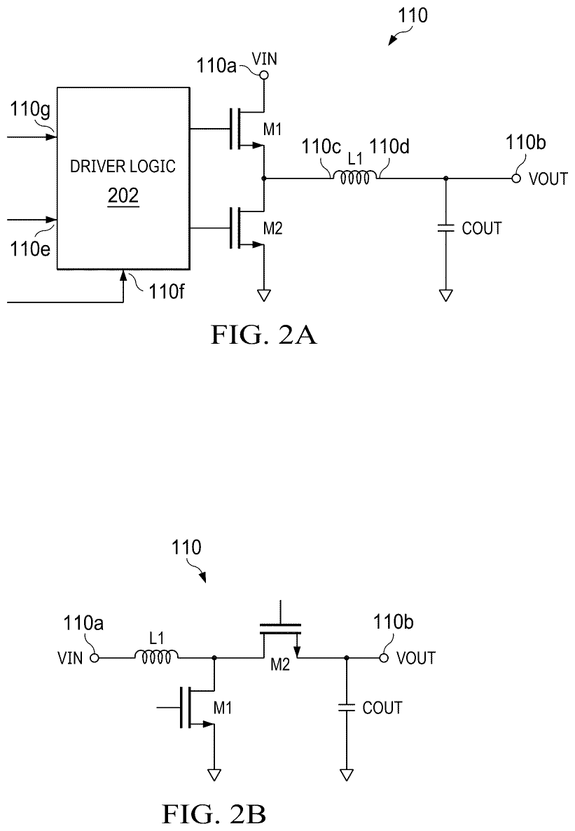

Power stage circuit 110 has voltage terminals 110a and 110b, terminals 110c and 110d, and inputs 110e, 110f, and 110g. Loop control circuit 116 has an input 116a and outputs 116b and 116c. Scaling circuit 120 has inputs 120a and 120b and outputs 120c and 120d. Input and output voltage terminals 101 and 102 of the switching converter 100 are coupled to terminals 110a and 110b, respectively, of power stage circuit 110. Power stage circuit 110, examples of which are provided in FIGS. 2A-2D and described below, may include a capacitor and one or more transistors through which current flows to inductor L1. The current through inductor L1 is IL.

Power stage circuit 110 may be a power stage circuit suitable, e.g., for a buck converter, a boost converter, or a buck-boost converter. FIGS. 2A, 2B, and 2C are circuit schematics of power stage circuit 110, in accordance with various embodiments of the present disclosure. In FIG. 2A, power stage circuit 110 is representative of a power stage circuit for a buck converter. Power stage circuit 110 in FIG. 2A includes driver logic 202, transistors M1 and M2, and a capacitor COUT. Transistors M1 and M2 may be any suitable type of transistors, such as n-channel field effect transistors (NFETs) as is shown in FIG. 2A. Alternatively, transistor M1 can be a p-channel field effect transistor (PFET). The source of transistor M1 is coupled to the drain of transistor M2 and to a terminal of inductor L1. The drain of transistor M1 is coupled to voltage terminal 110a (VIN), and the source of transistor M2 is coupled to a reference terminal (e.g., ground). Capacitor COUT is coupled between voltage terminal 110b and the reference terminal. Driver logic 202 receives control signals from loop control circuit 116. Driver logic 202 may include digital logic (e.g., logic gates, flip-flops, etc.) and gate drivers for transistors M1 and M2. An example implementation of driver logic 202 is provided in FIG. 2D and described below. Driver logic 202 may include a PWM control circuit and a PFM control circuit for controlling the on and off states of transistors M1 and M2 based on whether the converter is operating in the PWM mode or in the PFM mode. During the on-phase, driver logic 202 turns on transistor M1 and turns off transistor M2. During the off-phase, driver logic 202 turns on transistor M2 and turns off transistor M1. During a HIZ phase, driver logic turns off both of transistors M1 and M2.

In FIG. 2B, power stage circuit 110 is representative of a power stage circuit 110 for a boost converter, in accordance with an embodiment of the present disclosure. Power stage circuit 110 in FIG. 2B also includes transistors M1 and M2, and a capacitor COUT. Driver logic 202 is included but not shown. One terminal of inductor L1 is coupled to voltage terminal 110a, and the other terminal of inductor L1 is coupled to the drains of transistors M1 and M2. The source of transistor M1 is coupled to the reference terminal. The source of transistor M2 is coupled to one terminal of capacitor COUT and to the voltage terminal 110n. The other terminal of capacitor COUT is coupled to the reference terminal. During the on-phase, driver logic 202 turns on transistor M1 and turns off transistor M2. During the off-phase, driver logic 202 turns on transistor M2 and turns off transistor M1. During a HIZ phase, driver logic turns off both of transistors M1 and M2.

FIG. 2C is a schematic diagram of power stage circuit 110 suitable for use in a three-level switching converter in accordance with an embodiment of the present disclosure. As shown, power stage circuit 110 includes four switches (S1, S2, S3, and S4) coupled in series between voltage terminal 110a and the reference terminal. Each switch S1-S4 may be implemented as a transistor, Power stage circuit 110 in F-IG. 2C also includes a flying capacitor (C_FLY) with a charge+VIN/2. One terminal of capacitor C_FLY is coupled between switches S1 and S2, and the other terminal of capacitor C_FLY is coupled between switches S3 and S4. Driver logic 202 is included but not shown in FIG. 2C.

In operation for power stage circuit 110 of FIG. 2C, driver logic 202 provides control signals to control switches S1-S4 to thereby provide output pulses using a continuous conduction mode (CCM) or the PFM mode) to a voltage terminal 110b based on voltage VIN, VIN/2, and ground. To provide VIN to the voltage terminal 110b, driver logic 202 causes switches S1 and S2 to close (while switches S3 and S4 are open. To provide VIN/2 to the terminal 110b, driver logic 202 either causes switches S2 and S4 to close (while switches S1 and S3 are open) or causes switches S1 and S3 to close (while switches S2 and S4 are open). To provide the ground potential to voltage terminal 110b, driver logic 20′2 causes switches S3 and S4 to close (while switches S1 and S2 are open).

During an example CCM operation, driver logic 202 causes switches S1-S4 to switch between coupling VIN and VIN/2 to voltage terminal 110b at a fixed frequency. In another example CCM operation, driver logic 202 causes switches S1-S4 to switch between coupling VIN/2 and ground to the voltage terminal 110b at a fixed frequency, Operating switches S1-S4 allow the inductor to be magnetized or demagnetized. As desired, PWM may be used to vary the pulse width in the CCM while the frequency remains the same. Depending upon the power stage topology, the magnetizing aid demagnetizing of the inductor can be achieved with different turn on/off arrangement of the applicable switches.

During an example DCM operation, driver logic 202 causes switches S1-S4 to switch between coupling VIN, VIN/2, and ground to the voltage terminal 110b, where the frequency of pulses may be adjustable. In another example DCM operation, driver logic 202 causes switches S1-S4 to switch between coupling VIN and ground to the voltage terminal 110b, where the frequency of the pulses may be adjustable. As desired, PFM is used to adjust the frequency of pulses in the DCM.

FIG. 2D is a circuit schematic of an example driver logic 202. Driver logic 202 in FIG. 2D includes a PFM circuit 251, a PWM circuit 252, and a multiplexer 253. PFM circuit 251 generates control signals 255 for the gates of transistors M1 and M2 in the examples of FIGS. 2A and 2B. Additional control signals may be included for the three-level switching converter of FIG. 2C, Similarly, PWM circuit 252 generates control signals 256 for the gates of transistors M1 and M2 (and additional control signals for a multilevel converter). PFM circuit 251 and PWM circuit 252 may include logic (e.g., logic gates, flip-flops, comparators, etc.). PFM circuit 251 generates control signals 255 based on signals at inputs 110e and 110g. PWM circuit 252 generates control signals 256 based on a duty cycle signal DUTY, which may be a pulse that is logic high for the duration of the time that the inductor is magnetized, PFM circuit 251 controls the on and off states of transistors M1/M2 and switches S1-S4 during PPM operation, and PWM circuit 252 controls the on and off states of transistors M1/M2 and switches S1-S4 during PWM operation. Multiplexer 253 has a 0-input which receives control signals 255 and a 1-input which receives control signals 256. Based on a signal at input 110f, which is coupled to the multiplexer's selection input, multiplexer 253 either couples control signals 255 or control signals 256 to the multiplexer's outputs, which are coupled to the gates of transistors M1 and M2 (or to control inputs of switches S1-S4).

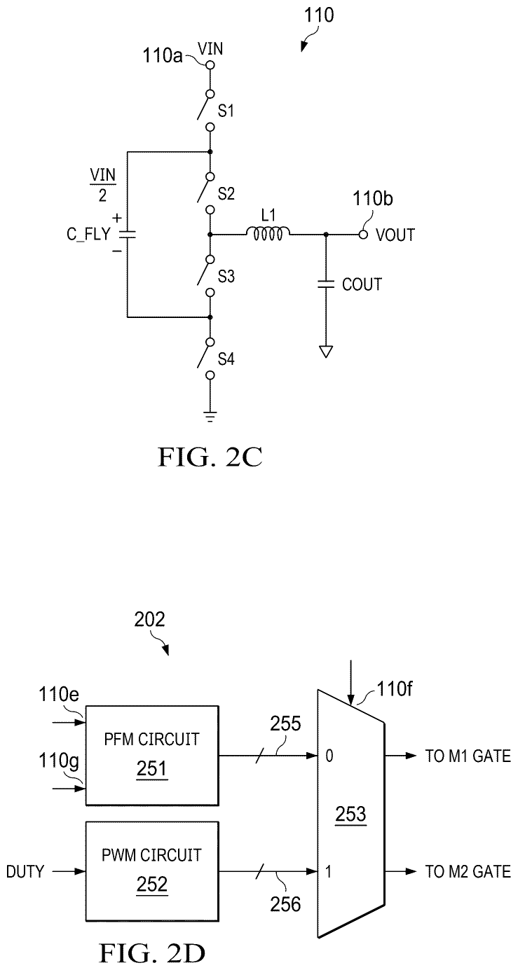

FIG. 3 is a waveform of inductor current IL for a switching cycle of a switching converter 100 during PFM mode. The switching cycle includes the on-phase 301, the off-phase 302, and the high impedance (HIZ) phase 303. During the on-phase 301, current flows to inductor L1 from voltage terminal 110a and the inductor current IL increases as shown at 311. In one example, the on-phase occurs when transistor M1 (FIGS. 2A and 2B) is on or switches S1 and S3 in FIG. 2C are on. During the off-phase 302, transistor M2 (FIGS. 2A and 2B) is on or switches S2 and S4 are on (FIG. 2C) thereby causing inductor current IL to continue to flow but decreasing as indicated at 312. During the HIZ phase 303, transistors M1 and M2 (FIGS. 2A and 2B) are off and switches S1-S4 are off (FIG. 2C) and inductor current IL is approximately 0 amperes as shown at 313. The length of the switching cycle is Ts. The length of the on-phase and off-phase is TON and TOFF, respectively, and the length of the HIZ phase is T_HIZ. The duty cycle of the HIZ phase

$$D\_HIZ = \frac{{T}_{HIZ}}{{T}_{S}} .$$

At lower load conditions, T_HIZ and D_HIZ increase, and at higher load conditions, T_HIZ and D_HIZ decrease.

Referring again to FIG. 1, during PWM operation, loop control circuit 116 may initiate a new switching cycle in accordance with a clock (e.g., internal to loop control circuit 116), which sets, for example, a fixed switching frequency. Loop control circuit 116 may assert (e.g., logic high) a control signal at its output 116b to input 110g of power stage circuit 110 to start a switching cycle. In response to the assertion of the control signal, power stage circuit 110 may initiate the on-phase during which inductor current IL increases. In other examples, loop control circuit 116 may control the switching period other than by using a fixed frequency clock, e.g. by way of constant on-time control, constant off-time control, valley control, etc. During PWM mode, scaling circuit 120 generates PEAK_REF, which during PWM mode may be set at a fixed value. When IL_SENSE reaches PEAK_REF, the output of comparator 126 changes logic state (e.g., from logic low to logic high). Power stage circuit 110 may respond to the change in logic state at the output of comparator 126 by discontinuing the on-phase and starting the off-phase. As described above, during the off-time, the inductor current IL decreases. Such switching cycles (on-phase followed by off-phase) repeat during PWM mode in accordance with the switching frequency. During PWM operation, the duty cycle of the switching converter dynamically adjusts to maintain VOUT at the regulated level. The duty cycle D for a boost converter is

$$D = 1 - \frac{VIN}{VOUT} .$$

The duty cycle for a buck converter is

$$D = \frac{VOUT}{VIN} .$$

For either boost or buck converters, during PWM if the load condition decreases (e.g., as the resistance of load 150 increases), the duty cycle of switching converter 100 decreases, and if the load condition increases, the duty cycle of switching converter 100 increases.

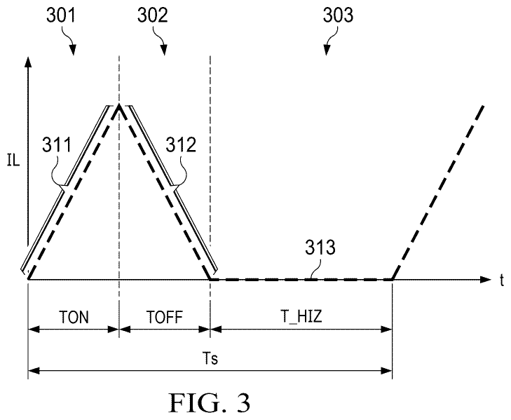

At relatively low load conditions, efficiency of the switching converter during PWM at a fixed switching frequency may decrease to an unacceptable level. Switching converter 100 may transition to the PFM mode of operation at lighter load conditions. FIG. 4 includes example waveforms IL_RIPPLE1 and IL_RIPPLE2 for a three-level switching boost converter. IL_RIPPLE1 and IL_RIPPLE2 represent inductor ripple current relative to VOUT for different values of VIN. In the example of FIG. 4, IL_RIPPLE1 is the ripple current relative to VOUT for a VIN of 2.5V, and IL_RIPPLE2 is the ripple current relative to VOUT for a VIN of 4.7V. As indicated at 410 and 412, the ripple current for a three-level switching converter is low (close to 0 amperes) when a three-level boost switching converter operates at approximately 50% duty. Because a switching converter may be operated at a duty cycle of approximately 50%, as described above, it may be problematic to set the PFM entry based on a zero-crossing of inductor current. This same problem may also be present for other types of converters such as a two-level switching converter.

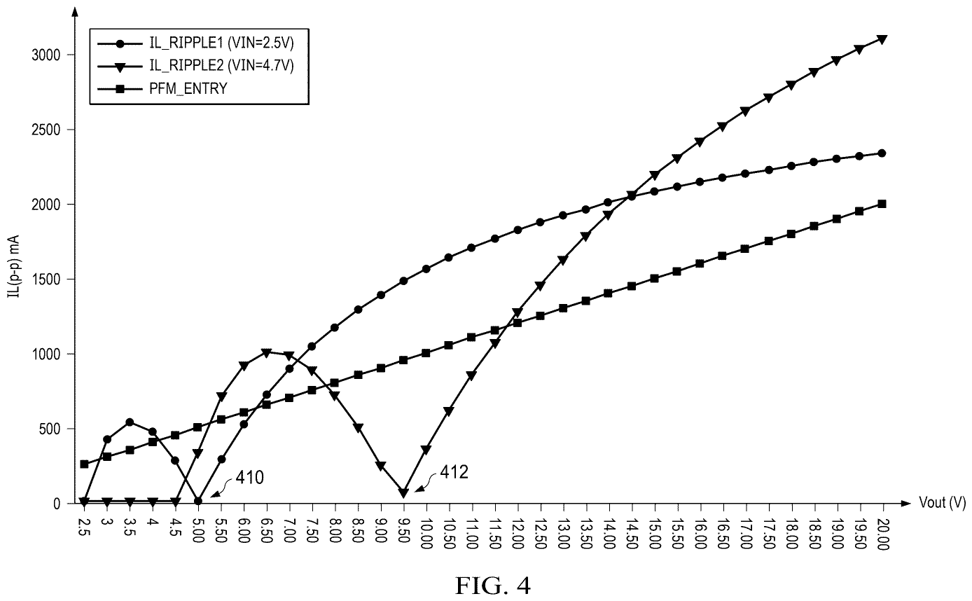

In accordance with an embodiment of the present disclosure, scaling circuit 120 generates PFM_ENTRY based on VOUT. FIG. 4 shows an example waveform for PFM_ENTRY. In one example, the relationship between PFM_ENTRY and VOUT can be determined apriori as a best fit curve for the various inductor ripple currents associated with a target range of VIN for a given switching converter 100. Scaling circuit 120 may sample VOUT and output a value for PFM_ENTRY based on the sampled VOUT. An example embodiment for scaling circuit 120 is provided in FIG. 5 and described below.

Averaging circuit 124 receives IL_SENSE as an input signal and generates an output signal IL_AVE. In an embodiment, averaging circuit 124 generates IL_AVE as the average of IL_SENSE. Averaging circuit 124 may include, for example, a filter such as a low-pass filter. The low-pass filter low-pass filters IL_SENSE to generate IL_AVE as an output signal. Comparator 128 compares PFM_ENTRY from scaling circuit 120 to IL_AVE from averaging circuit 124. If the output signal from comparator 128 changes logic state (e.g., from logic low to logic high), power stage circuit 110 responds by operating in the PFM mode (e.g., multiplexer 253 selects the 0-input from PFM circuit 251).

FIG. 5 is a circuit schematic of the scaling circuit 120 of switching converter 100 in FIG. 1, in accordance with an embodiment of the present disclosure. Scaling circuit 10 includes resistors R1-R5, a capacitor C1, and a switch SW1. Resistors R1, R3, and R2 are coupled in series between input 120a (VOUT) and ground. Switch SW1 (e.g., a transistor) is coupled across resistor R2. Switch SW1 has a control input coupled to input 120b. When signal HIZ is one logic state (e.g., logic high), switch SW1 closes and shorts resistor R2. When signal HIZ is another logic state (e.g., logic low), switch SW1 opens. The connection between resistors R1 and R3 is coupled to one terminal of resistor R4, and the other terminal of resistor R4 is coupled to output 120d. Output 120d provides PEAK_REF. Capacitor C1 is coupled between output 120d and ground. Resistor R4 and capacitor C1 form a filter, e.g., a low-pass filter. Signal HIZ may be logic high during the HIZ phase. As described above, the length of time of the HIZ phase is based on the load condition. Signal HIZ duty-cycles resistor R2 based on the load condition. During the HIZ phase, resistor R2 is shorted, and the voltage at the connection between resistors R1 and R3 is at a first voltage level, e.g.,

$$VOUT * \frac{R 3}{R 1 + R 3} .$$

When converter is not in the HIZ phase (either during the on-phase or the off-phase), resistor R2 is not shorted and the voltage at the connection between resistors R1 and R3 is at a second voltage level, e.g.,

$$VOUT * \frac{R 2 + R 3}{R 1 + R 2 + R 3} .$$

The duty cycle of the voltage at the connection between resistors R1 and R3 is thus based on the load condition. The filter formed by the combination of resistor R4 and capacitor C1 low-pass filters the voltage at the connection between resistors R1 and R3 signal PEAK_REF, which is an approximately direct current (DC) voltage based on the load condition. Resistors R5 and R6 form a voltage divider between input 120a and ground. The connection between resistors R5 and R6 is coupled to output 120c and provides signal PFM_ENTRY. Accordingly, signal PFM_ENTRY is a scaled version of VOUT.

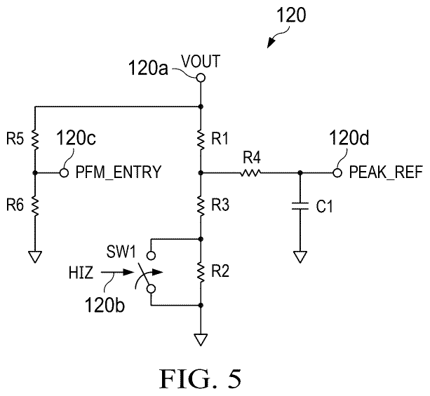

FIG. 6 is a circuit schematic of switching converter 100, in accordance with an embodiment of the present disclosure. Switching converter 100 in FIG. 6 is similar to switching converter 100 in FIG. 1. A difference between the switching converters of FIGS. 1 and 6 is that in FIG. 1, scaling circuit 120 has an input 120b which receives signal HIZ whereas in FIG. 6, scaling circuit 120 has an input 120e which receives a signal ISENSE. A current sense circuit 608 generates ISENSE based on the load current ILOAD. Signal ISENSE is thus based on the load condition. In FIG. 1, an indication of the load condition is provided to scaling circuit 120 by way of signal HIZ. In FIG. 6, however, the indication of the load condition is provided to scaling circuit 120 by way of signal ISENSE. As described above, scaling circuit 120 in FIG. 6 generates PFM_ENTRY based on VOUT and generates PEAK_REF based on VOUT and an indication of the load condition (ISENSE).

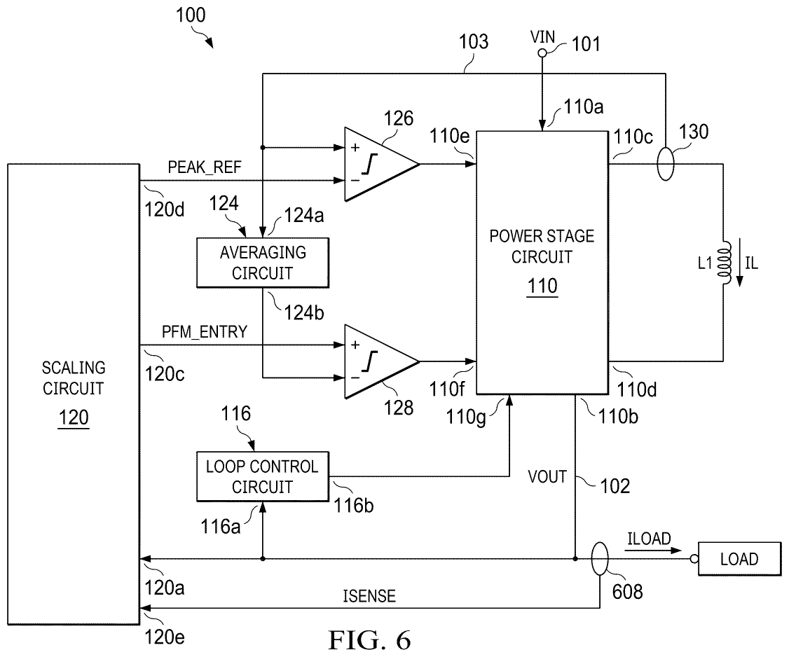

FIG. 7 is a circuit schematic of an example scaling circuit 120 for use in the switching converter 100 of FIG. 6. Scaling circuit 120 in FIG. 7 includes resistors R5 and R6 coupled together to provide a voltage divider to generate PFM_ENTRY, as described above. Multiplier 702 has inputs 702a and 702b and an output 702c. Multiplier 702 may be implemented as any suitable analog voltage multiplier. Input 702a is coupled to input 120a and receives VOUT. Input 702b is coupled to input 120e and receives ISENSE. Multiplier 702 multiplies VOUT by ISENSE to generate PEAK_REF at its output 702c. Accordingly, in FIG. 7 PEAK_REF is a VOUT scaled by ISENSE. For example, a smaller load condition (smaller ISENSE) results in a smaller value of PEAK_REF, and a larger load condition (larger ISENSE) results in a larger value of PEAK_REF.

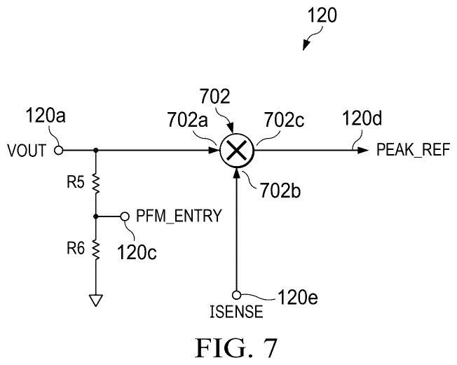

FIG. 8 is a circuit schematic of switching converter 100, in accordance with an embodiment of the present disclosure. Switching converter 100 in FIG. 8 is similar to switching converter 100 in FIG. 1. A difference between the switching converters of FIGS. 1 and 8 is that in FIG. 1, scaling circuit 120 does not include VIN has an input whereas in FIG. 8, scaling circuit 120 has an input 120f that is coupled to input voltage terminal 101 and receives VIN. As described above regarding FIGS. 1, 4, and 5, scaling circuit 120 in FIG. 5 generates PFM_ENTRY based on VOUT. In accordance, however, with the embodiment of FIG. 8, scaling circuit 120 generates PFM_ENTRY based on both VOUT and VIN.

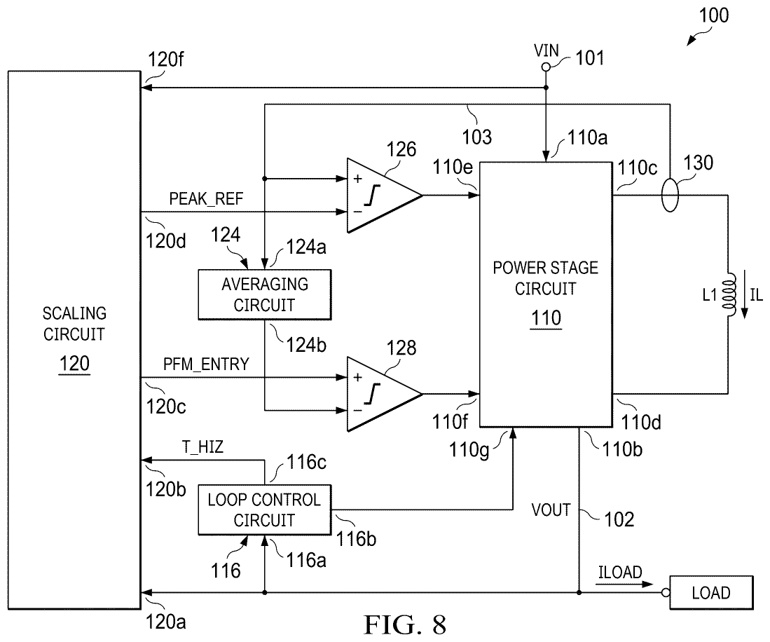

FIG. 9 is a circuit schematic of the scaling circuit 120 of FIG. 8, in accordance with an embodiment of the present disclosure. As described above, resistors R1-R4, capacitor C1, and switch SW1 are included to generate PEAK_REF. Resistors R7 and R8 are coupled in series between inputs 120a and 120f. Input 120a receives VOUT, and input 120f receives VIN, or a scaled version of VIN (α*VIN). Resistors R7 and R8 form a voltage divider to generate and output voltage at the connection between resistors R7 and R8 that is

$$( VOUT - α * VIN ) * \frac{R 8}{R 7 + R 8} .$$

The voltage at the connection between resistors R7 and R8 is provided to the upper terminal of resistor R1 for generation of PEAK_REF. Another voltage divider formed by the series coupling of resistors R9 and R10 may be included to further scale down the voltage

$$( VOUT - α * VIN ) * \frac{R 8}{R 7 + R 8}$$

to thereby generate PFM_ENTRY at output 120c.

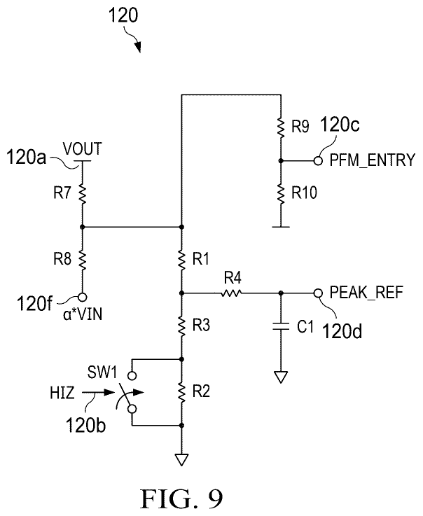

FIG. 10 is a circuit schematic of switching converter 100, in accordance with an embodiment of the present disclosure. As described above, switching converter 100 in FIG. 10 includes power stage circuit 110, inductor L1, loop control circuit 116, averaging circuit 124, and comparators 126 and 128. Scaling circuit 120 in this embodiment includes one or more resistor dividers (e.g., resistors R7/R8 and resistors R9/R10, described above) to generate PFM_ENTRY. Switching converter 100 in FIG. 10 includes a ramp generator 1004 and a summer 1002 to generate PEAK_REF. Ramp generator 1004 has an input 1004a and an output 1004b. Summer 1002 has a positive input, a negative input, and an output. The output 120c of scaling circuit 120 is coupled to the positive input of summer 1002. The output 1004b of ramp generator 1004 is coupled to the negative input of summer 1002. The output of summer 1002 provides PEAK_REF for the negative input of comparator 126. The output of comparator 126 is coupled to the input 1004a of ramp generator 1004.

Upon comparator 126 detecting that inductor current IL has reached PEAK_REF, the signal edge from comparator 126 (e.g., rising edge) causes ramp generator 1004 to reset RAMP_OUT and begin generating RAMP_OUT to linearly increase. Output 1004b of ramp generator is coupled to the negative input of summer 1002. Summer 1002 subtracts RAMP_OUT from PFM_ENTRY to thereby generate PEAK_REF. PEAK_REF decreases as a result of RAMP_OUT being subtracted from PFM_ENTRY. The switching period of the converter during PFM is based on the length of the HIZ phase, which is a proxy for the load condition.

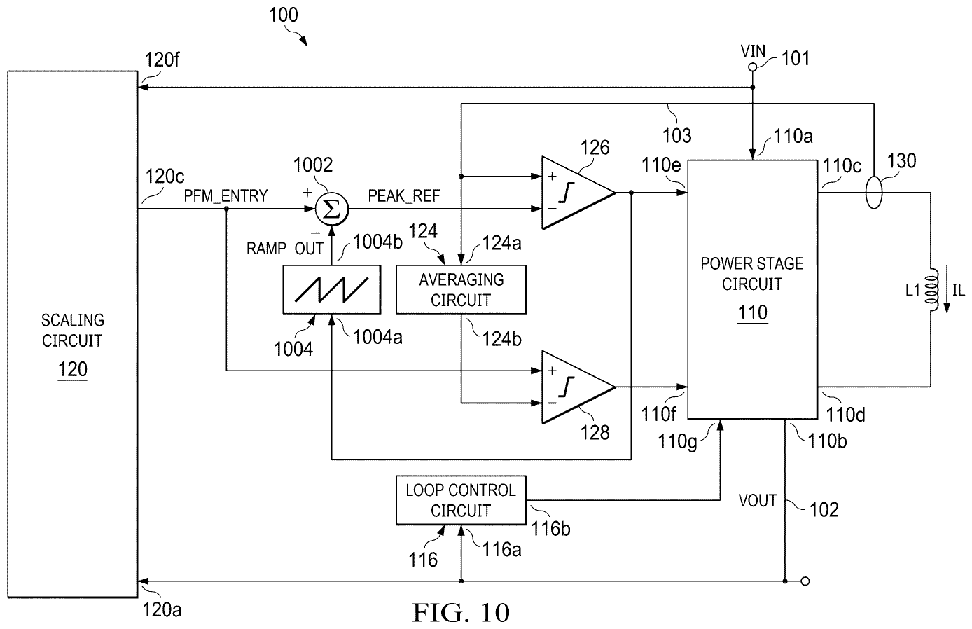

FIG. 11 is a circuit schematic of ramp generator 1004, in accordance with an embodiment of the present disclosure. Ramp generator 1004 includes a current source 1102, a clamp circuit 1108, a one-shot circuit 1110, a switch SW2, a capacitor C2, and a voltage reference V2. Input 1004a is coupled to an input 1110a of one-shot circuit 1110. One-shot circuit 1110 generates a short duration pulse at its output 11110b in response to, for example, a rising edge at input 1110a. The output 1110b of one-shot circuit 1110 is coupled to a control input of switch SW2. Switch SW2 is coupled across capacitor C2. Switch SW2 opens in response to the pulse from one-shot circuit 1110 and closes otherwise. That is, switch SW2 opens when comparator 126 detects that IL has reached PEAK_REF. Capacitor C2 is coupled in series with voltage reference V2 between output 1004b and ground. Current source circuit 1102 is coupled to capacitor C2. Clamp circuit 1108 is coupled between output 1004b and ground. When activated, clamp circuit 1108 clamps the voltage at output 1004b at a voltage V1, where V1 is greater than V2.

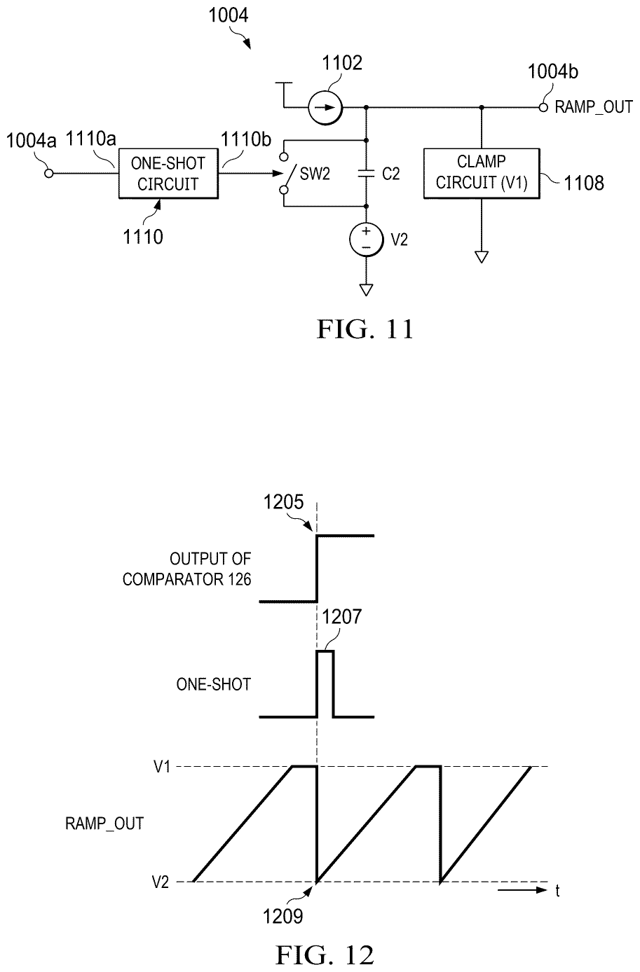

FIG. 12 are waveform illustrating RAMP_OUT, the output of comparator 126, and a one-shot pulse from one-shot circuit 1110, in an example. When comparator 126 detects the IL has reached PEAK_REF, the logic state of the output of comparator 126 changes from logic low to logic high as indicated 1205. That rising edge causes on-shot circuit 1110 to generate a pulse 1207, which closes switch SW2 to reset the ramp generator 1004. With switch SW2 closed, capacitor C2 discharges and RAMP_OUT is pulled down to V2, as indicated at 1209. Then, switch SW2 opens and current from current source 1102 charges capacitor C2 thereby causing RAMP_OUT to increase approximately linearly. RAMP_OUT increases until voltage V1 is reached at which point clamp circuit 1108 clamps RAMP_OUT at voltage V1.

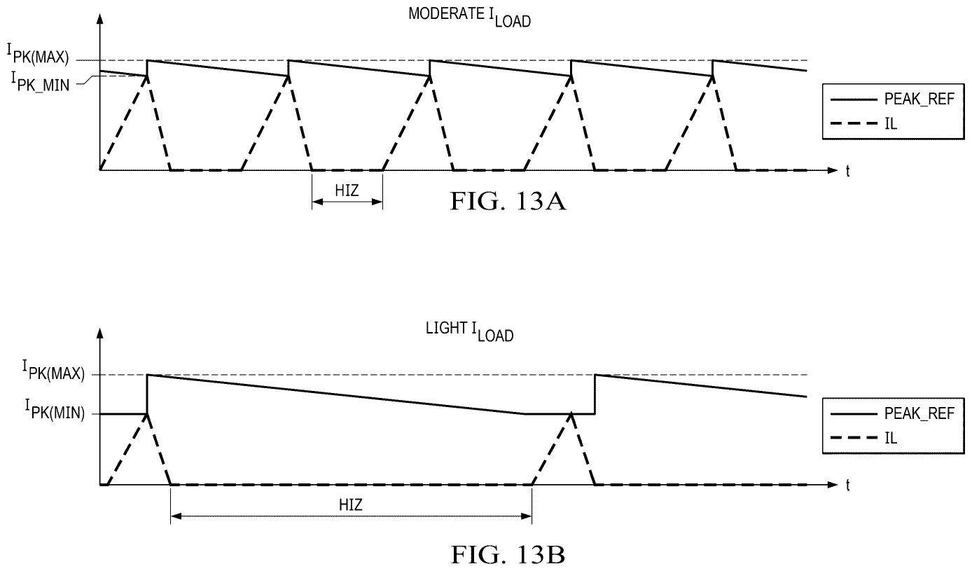

FIGS. 13A and 13B include waveforms for inductor current IL and PEAK_REF at the output of summer 1002 of FIG. 10. The example of FIG. 13A corresponds to a moderate load condition, and the example of FIG. 13B corresponds to a light load condition. In either case, in response to IL reaching PEAK_REF, the ramp generator 1004 is reset as described above and an increasing RAMP_OUT, RAMP_OUT is subtracted from PFM_ENTRY to generate a linearly decaying PEAK_REF. The switching frequency in FIG. 13A for the moderate load condition is higher than for the light load condition because the HIZ phase is longer for the light load condition compared to the moderate load condition.

Example embodiments of the present disclosure are summarized here. Other embodiments can also be understood from the entirety of the specification and the claims filed herein.

Example 1. An apparatus including: a power stage circuit having a first control input, a first voltage terminal, and a second voltage terminal; a comparator having a first input, a second input, and an output, the output coupled to the first control input; a current sense terminal coupled to the second input of the comparator; and a scaling circuit having a first input and an output, the first input of the scaling circuit coupled to the second voltage terminal, and the output of the scaling circuit coupled to the first input of the comparator, the scaling circuit is configured to generate a first signal at the output of the scaling circuit based on a voltage at the first input of the scaling circuit, where the power stage circuit is configured to enable pulse frequency modulation (PFM) based on a change in logic state of a second signal at the output of the comparator from a first logic state to a second logic state.

Example 2. The apparatus of example 1, where the power stage circuit has a second control input, the comparator is a first comparator, the output of the scaling circuit is a first output, and the scaling circuit includes a second input and a second output, and the apparatus further includes: a loop control circuit having an input coupled to the second voltage terminal and having a first output and a second output, the first output of the loop control circuit coupled to the second input of the scaling circuit, and the second output of the loop control circuit coupled to the power stage circuit; and a second comparator having a first input, a second input, and an output, the output of the second comparator coupled to the second control input of the power stage circuit, the first input of the second comparator coupled to the current sense terminal, and the second input of the second comparator coupled to the second output of the scaling circuit.

Example 3. The apparatus of one of examples 1 or 2, the scaling circuit is configured to generate a third signal at the second output of the scaling circuit based on a voltage at the second voltage terminal and a signal at the second input of the scaling circuit.

Example 4. The apparatus of one of examples 1 to 3, where the scaling circuit has a third input coupled to the first voltage terminal, and the scaling circuit is configured to generate the third signal based also on a voltage at the third input.

Example 5. The apparatus of one of examples 1 to 4, where the scaling circuit includes a resistor divider coupled between the first input of the scaling circuit and a reference terminal, the resistor divider including a resistor and a switch coupled across the resistor, the switch configured to be controlled by a signal at the second input of the second output of the scaling circuit.

Example 6. The apparatus of one of examples 1 to 5, where the scaling circuit further includes a filter having an input coupled to an output of the resistor divider and having an output coupled to the second input of the second comparator.

Example 7. The apparatus of one of examples 1 to 6, where the filter is a low-pass filter.

Example 8. The apparatus of one of examples 1 to 7, further including an averaging circuit having an input and an output, the input of the averaging circuit coupled to the current sense terminal, and the output of the averaging circuit coupled to the second input of the first comparator.

Example 9. The apparatus of one of examples 1 to 8, further including an averaging circuit having an input coupled to the current sense terminal and having an output coupled to the second input of the comparator.

Example 10. The apparatus of one of examples 1 to 9, where the averaging circuit is configured to generate a signal at the output of the averaging circuit indicative of an average of a signal at the current sense terminal.

Example 11. The apparatus of one of examples 1 to 10, where the scaling circuit is configured to generate the signal at the output of the scaling circuit by scaling a voltage at the first input of the scaling circuit.

Example 12. The apparatus of one of examples 1 to 11, where the current sense terminal is a first current sense terminal, the power stage circuit has a second control input, the comparator is a first comparator, the output of the scaling circuit is a first output, and the scaling circuit includes a second input and a second output, the second input of the scaling circuit coupled to a second current sense terminal, and where the apparatus further includes a second comparator having a first input, a second input, and an output, the output of the second comparator coupled to the second control input of the power stage circuit, the first input of the second comparator coupled to the first current sense terminal, and the second input of the second comparator coupled to the second output of the scaling circuit.

Example 13. The apparatus of one of examples 1 to 12, where the scaling circuit includes a multiplier having a first input coupled to the first input of the scaling circuit and having a second input coupled to the second input of the scaling circuit, the multiplier also having an output coupled to the second output of the scaling circuit.

Example 14. The apparatus of one of examples 1 to 13, where the power stage circuit includes a second control input, the comparator is a first comparator, and the apparatus further includes: a summer having first and second inputs and an output, the first input coupled to the output of the scaling circuit; a ramp generator having an output coupled to the second input of the summer; and a second comparator having first and second inputs and an output, the first input of the second comparator coupled to the output of the summer, the second input of the second comparator coupled to the current sense terminal, and the output of the second comparator coupled to the current sense terminal.

Example 15. The apparatus of one of examples 1 to 14, where the summer is configured to subtract a signal at the second input of the summer from a signal at the first input of the summer.

Example 16. An apparatus including: a power stage circuit including a transistor and having a first control input, a first voltage terminal, and a second voltage terminal; a comparator having a first input, a second input, and an output, the output coupled to the first control input; a current sense terminal coupled to the first input of the comparator; and a scaling circuit having a first input, a second input, and an output, the first input of the scaling circuit coupled to the second voltage terminal, and the output of the scaling circuit coupled to the second input of the comparator, the scaling circuit is configured to generate a first signal at the output of the scaling circuit based on a voltage at the first input of the scaling circuit and a second signal at the second input of the scaling circuit, where the power stage circuit is configured to turn off the transistor in response to a third signal at the output of the comparator changing from a first logic state to a second logic state.

Example 17. The apparatus of example 16, where the scaling circuit includes a resistor divider coupled between the first input of the scaling circuit and a reference terminal, the resistor divider including a resistor and a switch coupled across the resistor, the switch configured to be controlled by the third signal.

Example 18. The apparatus of one of examples 16 or 17, further including a loop control circuit having an input coupled to the second voltage terminal and having a first output and a second output, the first output of the loop control circuit coupled to a control input of the switch, and the second output of the loop control circuit coupled to the power stage circuit.

Example 19. The apparatus of one of examples 16 to 18, where the scaling circuit further includes a filter having an input coupled to an output of the resistor divider and having an output coupled to the output of the scaling circuit.

Example 20. The apparatus of one of examples 16 to 19, where the scaling circuit has a second output, the power stage circuit has a second control input, and the comparator is a first comparator, and where the apparatus further includes a second comparator having first and second inputs and an output, the first input of the second comparator coupled to the second output of the scaling circuit, the output of the second comparator coupled to the second control input, and the second input of the second comparator coupled to the current sense terminal.

Example 21. The apparatus of one of examples 16 to 20, further including an averaging circuit having an input and an output, the input of the averaging circuit coupled to the current sense terminal, and the output of the averaging circuit coupled to the second input of the second comparator.

Example 22. The apparatus of one of examples 16 to 21, where the scaling circuit is configured to generate a fourth signal at the second output of the scaling circuit based on a voltage at the first input of the scaling circuit.

Example 23. The apparatus of one of examples 16 to 22, where the scaling circuit is configured to generate the fourth signal at the second output of the scaling circuit also based on a reference voltage.

Example 24. The apparatus of one of examples 16 to 23, where the scaling circuit has a third input coupled to the first voltage terminal, and the reference voltage is a voltage at the third input of the scaling circuit.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (S1), a silicon carbide substrate (SiC), a gallium nitride substrate (GaN) or a gallium arsenide substrate (GaAs).

Circuits described herein may be reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. An apparatus comprising:
a power stage circuit having a first control input, a first voltage terminal, and a second voltage terminal;
a comparator having a first input, a second input, and an output, the output coupled to the first control input;
a current sense terminal coupled to the second input of the comparator; and
a scaling circuit having a first input and an output, the first input of the scaling circuit coupled to the second voltage terminal, and the output of the scaling circuit coupled to the first input of the comparator, the scaling circuit is configured to generate a first signal at the output of the scaling circuit based on a voltage at the first input of the scaling circuit, wherein the power stage circuit is configured to enable pulse frequency modulation (PFM) based on a change in logic state of a second signal at the output of the comparator from a first logic state to a second logic state.

2. The apparatus of claim 1, wherein the power stage circuit has a second control input, the comparator is a first comparator, the output of the scaling circuit is a first output, and the scaling circuit includes a second input and a second output, and the apparatus further includes:
a loop control circuit having an input coupled to the second voltage terminal and having a first output and a second output, the first output of the loop control circuit coupled to the second input of the scaling circuit, and the second output of the loop control circuit coupled to the power stage circuit; and
a second comparator having a first input, a second input, and an output, the output of the second comparator coupled to the second control input of the power stage circuit, the first input of the second comparator coupled to the current sense terminal, and the second input of the second comparator coupled to the second output of the scaling circuit.

3. The apparatus of claim 2, the scaling circuit is configured to generate a third signal at the second output of the scaling circuit based on a voltage at the second voltage terminal and a signal at the second input of the scaling circuit.

4. The apparatus of claim 3, wherein the scaling circuit has a third input coupled to the first voltage terminal, and the scaling circuit is configured to generate the third signal based also on a voltage at the third input.

5. The apparatus of claim 2, wherein the scaling circuit includes a resistor divider coupled between the first input of the scaling circuit and a reference terminal, the resistor divider including a resistor and a switch coupled across the resistor, the switch configured to be controlled by a signal at the second input of the second output of the scaling circuit.

6. The apparatus of claim 5, wherein the scaling circuit further includes a filter having an input coupled to an output of the resistor divider and having an output coupled to the second input of the second comparator.

7. The apparatus of claim 6, wherein the filter is a low-pass filter.

8. The apparatus of claim 2, further comprising an averaging circuit having an input and an output, the input of the averaging circuit coupled to the current sense terminal, and the output of the averaging circuit coupled to the second input of the first comparator.

9. The apparatus of claim 1, further comprising an averaging circuit having an input coupled to the current sense terminal and having an output coupled to the second input of the comparator.

10. The apparatus of claim 9, wherein the averaging circuit is configured to generate a signal at the output of the averaging circuit indicative of an average of a signal at the current sense terminal.

11. The apparatus of claim 1, wherein the scaling circuit is configured to generate the signal at the output of the scaling circuit by scaling a voltage at the first input of the scaling circuit.

12. The apparatus of claim 1, wherein the current sense terminal is a first current sense terminal, the power stage circuit has a second control input, the comparator is a first comparator, the output of the scaling circuit is a first output, and the scaling circuit includes a second input and a second output, the second input of the scaling circuit coupled to a second current sense terminal, and wherein the apparatus further includes a second comparator having a first input, a second input, and an output, the output of the second comparator coupled to the second control input of the power stage circuit, the first input of the second comparator coupled to the first current sense terminal, and the second input of the second comparator coupled to the second output of the scaling circuit.

13. The apparatus of claim 12, wherein the scaling circuit includes a multiplier having a first input coupled to the first input of the scaling circuit and having a second input coupled to the second input of the scaling circuit, the multiplier also having an output coupled to the second output of the scaling circuit.

14. The apparatus of claim 1, wherein the power stage circuit includes a second control input, the comparator is a first comparator, and the apparatus further includes:
a summer having first and second inputs and an output, the first input coupled to the output of the scaling circuit;
a ramp generator having an output coupled to the second input of the summer; and
a second comparator having first and second inputs and an output, the first input of the second comparator coupled to the output of the summer, the second input of the second comparator coupled to the current sense terminal, and the output of the second comparator coupled to the current sense terminal.

15. The apparatus of claim 14, wherein the summer is configured to subtract a signal at the second input of the summer from a signal at the first input of the summer.

16. An apparatus comprising:
a power stage circuit including a transistor and having a first control input, a first voltage terminal, and a second voltage terminal;
a comparator having a first input, a second input, and an output, the output coupled to the first control input;
a current sense terminal coupled to the first input of the comparator; and
a scaling circuit having a first input, a second input, and an output, the first input of the scaling circuit coupled to the second voltage terminal, and the output of the scaling circuit coupled to the second input of the comparator, the scaling circuit is configured to generate a first signal at the output of the scaling circuit based on a voltage at the first input of the scaling circuit and a second signal at the second input of the scaling circuit, wherein the power stage circuit is configured to turn off the transistor in response to a third signal at the output of the comparator changing from a first logic state to a second logic state.

17. The apparatus of claim 16, wherein the scaling circuit includes a resistor divider coupled between the first input of the scaling circuit and a reference terminal, the resistor divider including a resistor and a switch coupled across the resistor, the switch configured to be controlled by the third signal.

18. The apparatus of claim 17, further including a loop control circuit having an input coupled to the second voltage terminal and having a first output and a second output, the first output of the loop control circuit coupled to a control input of the switch, and the second output of the loop control circuit coupled to the power stage circuit.

19. The apparatus of claim 17, wherein the scaling circuit further includes a filter having an input coupled to an output of the resistor divider and having an output coupled to the output of the scaling circuit.

20. The apparatus of claim 16, wherein the scaling circuit has a second output, the power stage circuit has a second control input, and the comparator is a first comparator, and wherein the apparatus further includes a second comparator having first and second inputs and an output, the first input of the second comparator coupled to the second output of the scaling circuit, the output of the second comparator coupled to the second control input, and the second input of the second comparator coupled to the current sense terminal.

21. The apparatus of claim 20, further including an averaging circuit having an input and an output, the input of the averaging circuit coupled to the current sense terminal, and the output of the averaging circuit coupled to the second input of the second comparator.

22. The apparatus of claim 21, wherein the scaling circuit is configured to generate a fourth signal at the second output of the scaling circuit based on a voltage at the first input of the scaling circuit.

23. The apparatus of claim 22, wherein the scaling circuit is configured to generate the fourth signal at the second output of the scaling circuit also based on a reference voltage.

24. The apparatus of claim 23, wherein the scaling circuit has a third input coupled to the first voltage terminal, and the reference voltage is a voltage at the third input of the scaling circuit.
